(19) United States
(12) Patent Application Publication
(10) Pub. No.: US 2017/0004259 A1
(43) Pub. Date: Jan. 5, 2017

(54) AUTOMATIC CONTEXTUAL LOGIN USING REAL TIME LOCATING SYSTEM INFORMATION

(71) Applicant: Hill-Rom Services, Inc., Batesville, IN (US)

(72) Inventors: Andrew S. Robinson, Durham, NC (US); Joshua P. Lingenfelser, Fuquay Varina, NC (US); Matthew D. Morgan, Cary, NC (US); Bradley T. Smith, Raleigh, NC (US); Christian Saucier, Raleigh, NC (US)

(21) Appl. No.: 15/186,956

(22) Filed: Jun. 20, 2016

Related U.S. Application Data
(60) Provisional application No. 62/186,803, filed on Jun. 30, 2015.

(51) Int. Cl. G06F 19/00

(52) U.S. Cl. CPC G06F 19/323; G06F 19/327

(57) ABSTRACT

Based on a patient's and a caregiver's presence being detected in the same room by a locating system, the caregiver is automatically logged into a computer in the room. An initial screen that appears on a display screen of the computer is a screen that is specific for the patient that is located in the room. The initial screen comprises a patient's electronic medical record and the caregiver uses the computer to enter data or information into the electronic medical record of the patient. More broadly, a first person is logged into a computer in response to the presence of the first person and a second person being detected at the same location by a locating system.

The present application claims the benefit, under 35 U.S.C. §119(e), of U.S. Provisional Application No. 62/186,803, which was filed Jun. 30, 2015, and which is hereby incorporated by reference herein in its entirety.

### BACKGROUND

The present disclosure relates to logging users into computers and particularly, to using wirelessly transmitted information in connection with logging users into computers. More particularly, the present disclosure relates to an automatic login system that logs users into computers so that different users are presented user-specific screens upon logging into a computer.

In the healthcare environment, caregivers oftentimes enter and exit a large number of rooms throughout their shift. For example, a caregiver may enter into a number of patient rooms to attend to patients in the respective rooms. In some healthcare facilities, some or all of the patient rooms have a computer which is in communication with a network of the healthcare facility. Caregivers also enter other rooms in healthcare facilities that have patients and computers therein such as physical therapy rooms, laboratory rooms, intensive care unit (ICU) rooms, imaging rooms, and so forth.

If a caregiver wishes to retrieve information using a computer in a particular room, or to enter data using a computer in a particular room, it is usually necessary for the caregiver to log into the computer and then pull up a desired screen on a display of the computer. Depending upon the room in which the caregiver and patient is located and the activities occurring in that room, the caregiver may be required to navigate to a particular software application and enter particular data or information concerning a particular patient. This reduces caregiver efficiency because the caregiver has to log into multiple computers in the various rooms the caregiver enters and to navigate to particular software applications in some instances. If the caregiver forgets to log out of the computer in a room that the caregiver previously entered, the caregiver may not even be able to log into another computer in a different room. Thus, the caregiver then has to return to the previous room and log out. Caregivers would appreciate a system that improves their efficiency in connection with the use of computers throughout a healthcare facility. Caregivers would also appreciate a system that pulls up a desired screen, such as for data entry, without the need to navigate to the software application having the specific screen.

### SUMMARY

An apparatus, system or method may comprise one or more of the features recited in the appended claims and/or the following features which, alone or in any combination, my comprise patentable subject matter:

According to an aspect of the present disclosure, a system may include a first identification token that may be carried by a caregiver and a second identification token that may be carried by a patient. A receiver of the system may be located in a patient room and may be operable to communicate wirelessly with the first and second identification tokens when the first and second identification tokens are located in the patient room. The system may further include a computer located in the patient room and the computer may have a display screen. At least one server may be in communication with the receiver. The at least one server may associate the caregiver and the patient with the patient room based on information that may be received from the receiver and that may be sent to the first server. Based on the at least one server associating the caregiver and the patient with the room, the at least one server may determine an initial screen from among a plurality of possible initial screens to be shown on the display screen of the computer. The at least one server may send the computer at least one message that automatically may log the caregiver into the computer and that may result in the initial screen being displayed on the display screen of the computer.

In some embodiments, the caregiver may be logged out of the computer automatically in response to the first identification token losing communication with the receiver for a threshold amount of time. Alternatively or additionally, the initial screen may cease to be displayed on the display screen in response to the first identification token losing communication with the receiver for a threshold amount of time. Further alternatively or additionally, the caregiver may be logged out of the computer automatically in response to the caregiver leaving the patient room. Still further alternatively or additionally, the initial screen may cease to be displayed on the display screen in response to the caregiver leaving the patient room.

In some embodiments, after the caregiver is logged into the computer, the caregiver may remain logged into the computer even if the second identification token loses communication with the receiver for a threshold amount of time. It is contemplated by this disclosure that after, the caregiver is logged into the computer, the initial screen may remain displayed on the graphical display even if the second identification token loses communication with the receiver for a threshold amount of time. Alternatively or additionally, after the caregiver is logged into the computer, the caregiver may remain logged into the computer even if the patient leaves the patient room. Further alternatively or additionally, after the caregiver is logged into the computer, the initial screen may remain displayed on the graphical display even if the patient leaves the patient room.

In some embodiments, the initial screen includes information that may be obtained from an electronic medical record (EMR) of the patient. In some embodiments, the at least one server may receive computer identification data that may identify the computer and the at least one server also may associate the computer identification data with the room. The at least one server may include a first server and a second server and the computer identification data may be communicated to the first server via the second server. Alternatively or additionally, the computer identification data may be communicated to the at least one server via the receiver. In some embodiments, a third identification token may be coupled to the computer and the third identification token may transmit the computer identification data to the receiver.

According to another aspect of the present disclosure, a system may include a first identification token that may be carried by a caregiver, a second identification token that may be carried by a patient, a receiver that may be located in a patient room and that may be operable to communicate wirelessly with the first and second identification tokens when the first and second identification tokens are located in the patient room, and a computer that may be located in the patient room and that may have a display screen. A server may be in communication with the receiver. The server may associate the caregiver and the patient with the patient room based on information that may be received from the receiver and that may be sent to the server. The server may transmit association data to the computer that may indicate the association of the caregiver and the patient with the room. In response to receipt of the association data, the computer may automatically log the caregiver into the computer and may display on the display screen information that may pertain to the patient.

In some embodiments, the caregiver may be logged out of the computer automatically in response to the first identification token losing communication with the receiver for a threshold amount of time. Alternatively or additionally, the caregiver may be logged out of the computer automatically in response to the caregiver leaving the patient room. In some embodiments, after the caregiver is logged into the computer, the caregiver may remain logged into the computer even if the second identification token loses communication with the receiver for a threshold amount of time. Alternatively or additionally, after the caregiver is logged into the computer, the caregiver may remain logged into the computer even if the patient leaves the patient room. In some embodiments, the information pertaining to the patient may be obtained from an electronic medical record (EMR) of the patient.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying drawings, in which:

FIG. 1 is a block diagram showing a patient and caregiver each being located in a room and having a respective tag that communicates wirelessly with a real time locating system (RTLS) receiver, the RTLS receiver being in communication with an RTLS server that is coupled to a login server via a network, and the login server being coupled to a computer in the room via the network; and

FIG. 2 is a table that shows, diagrammatically, initial screens that appear on a display screen of the computer in the room based on various combinations of caregivers and patients being located in the room.

### DETAILED DESCRIPTION

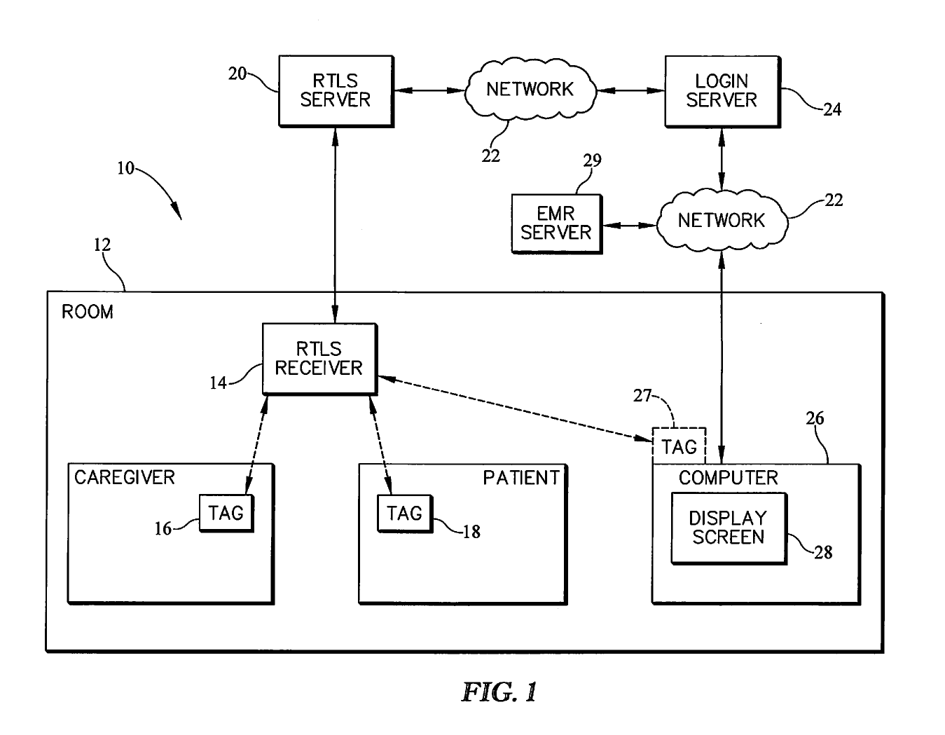

A system 10 is provided for automatically logging a first person into a computer based on the presence of the first person and the presence of a second person being detected in the same room 12 as shown diagrammatically in FIG. 1. In the description that follows, system 10 is described in the context of a healthcare environment. However, it should be appreciated that system 10 has utility in other environments as well.

Still referring to FIG. 1, system 10 includes a real time locating system (RTLS) receiver 14 that is located in room 12 and that receives wireless signals from a token or tag 16 of a caregiver and a token or tag 18 of a patient. Tags 16, 18 are carried by the respective caregiver and patient, such as by being clipped or otherwise attached to the clothing of the caregiver or patient, as the case may be. However, while tags 16, 18 are the given example of tokens that are carried by caregivers and patents, other tokens such as wrist bands, key fobs, wireless phones, necklace pendants, and so forth may be used in addition to, or in lieu of, tags 16, 18 in some contemplated systems 10.

Tag 16 sends caregiver identification (ID) data to receiver 14 and tag 18 sends patient ID data to receiver 14. In some embodiments, the ID data is transmitted by either or both of tags 16, 18 at predetermined time intervals such as, for example, every three seconds or every thirty seconds, just to name a couple arbitrary time period examples. In other embodiments, tags 16, 18 transmit the respective ID data in response to receipt of a signal from receiver 14 or some other device such as a separate locator unit (not shown). In this latter embodiment, battery life of tags 16, 18 is conserved because transmissions occur only under those circumstances in which receiver 14 is in communicative proximity with tags 16, 18.

Receiver 14 is included as part of a transceiver in some embodiments. Thus, the double headed dashed arrows between tags 16, 18 and receiver 14 in FIG. 1 indicates that bidirectional (e.g., two-way) communication exists between tags 16, 18 and receiver 14. However, it is not necessarily the case that the wireless communication technology used for communications from receiver 14 to tags 16, 18 is the same as the wireless communication technology used for communication from tags 16, 18 to receiver 14 or even the wireless communication technology used for communication from a locator unit to tags 16, 18. The communication technology from receiver 14 (and/or the locator unit in some embodiments) to tags 16, 18 may be one of infrared (IR), radio frequency (RF), ultrasound (US), ultra wide band (UWB), or ultra-low frequency (ULF) and the communication from tags 16, 18 to receiver 14 (and/or the locator unit) may be another of IR, RF, US, UWB, or ULF. Receiver 14 may be included as part of a wireless access point (WAP) that communicates using WiFi technology in some embodiments.

Receiver 14 sends the caregiver ID data and the patient ID data to RTLS server 20. In some embodiments, receiver 14 also transmits RTLS receiver ID data and/or locator unit ID data to RTLS server 20. The RTLS receiver ID data or location unit ID data, as the case may be, correlates to the room 12 in which receiver 14 or the location unit is located. Server 20, therefore, associates the caregiver ID data from tag 16, the patient ID data from tag 18, and the room ID data from receiver 14 (or locator unit) with each other to indicate which caregiver and patient is in which room. It should be appreciated that a healthcare facility has a multitude of rooms 12 with receivers 14 that are in communication with server 20 to track the whereabouts of a multitude of caregivers and patients throughout the healthcare facility. Thus, the tags 16, 18, receivers 14, and server 20 together are considered to be a real time locating system (RTLS) which is sometimes referred to as a locating and tracking system or just a locating system.

In the illustrative example, RTLS server 20 communicates through a network 22 of the healthcare facility with a login server 24. However, it is contemplated by this disclosure that functions performed by server 20 and the functions performed by server 24 may just as well be performed on a single server. That is, in some embodiments, the software controlling the locating and tracking functionality of RTLS server and the software controlling the login functionality of server 24 reside on a single server. It is also contemplated by this disclosure that login server 24 may also have the software, and therefore, the functionality of other servers in network 22 of a healthcare facility. Thus, login server 24 also functions as a nurse call server, an admission/discharge/transfer (ADT) server, an electronic medical records (EMR) server, or a workflow server, just to name a few, in some embodiments. Furthermore, although a double headed arrow interconnects receiver 14 with server 20 which implies a connection that does not involve network 22 (e.g., direct cabling between receiver 14 to server 20), it is within the scope of this disclosure for the communication between receiver 14 and server 20 to also include the infrastructure of network 22.

Still referring to FIG. 1, server 24 is coupled to a computer 26 in room 12 via network 22. Computer 26 includes a display screen 28. In some embodiments, an Internet Protocol (IP) address or a media access control (MAC) address of computer 26 correlates to the room 12 in which computer 26 is located. Thus, a database in server 20 and/or server 24 stores information regarding the location of computer 26 based on the IP or MAC address of computer 26 as communicated to server 24 via network 22. Alternatively or additionally, a tag 27 is attached to computer 26 and communicates with RTLS server 20 via RTLS receiver 14 as shown in FIG. 1 (in phantom). Use of tag 27 to track the whereabouts of a particular computer 26 may be more appropriate if the particular computer 26 is one that is intended to be transported throughout a healthcare facility, such as a tablet computer or computer on wheels (COW) (e.g., a computer attached to a wheeled cart). For those computers 26 that are dedicated to a particular room 12 so as to remain in the same room 12 for an extended period of time, then tag 27 may be omitted and the location correlated based on IP or MAC address as discussed above.

According to this disclosure, depending upon the identity of the caregiver, as indicated by the ID data from tag 16, and the identity of the patient, as indicated by tag 18, that are sensed by receiver 14 to be in room 12, login server 24 sends one or more messages to computer 26 to automatically log the caregiver into computer 26 and to display an initial screen on display screen 28. Thus, the caregiver does not need to make any keystrokes or otherwise enter any information at computer 26 in order to log in to computer 26. Logging into computer 26 is also considered to be logging into network 22 according to this disclosure. That is, once the caregiver is logged into computer 26, the caregiver is able to navigate to various software applications available on the various computer devices, including servers 20, 24, that are included as part of, or otherwise in communication with, network 22.

In some embodiments, server 24 contains login information such as the user ID and password for each of the caregivers who are to be logged in automatically to computers 26 in the various rooms 12 of the respective healthcare facility. Thus, when server 24 is notified by server 20 that a particular caregiver has entered room 12 of a particular patient, server 24 responds by transmitting the login information to computer 26 along with commands that result in the caregiver being logged into computer 26 in some embodiments. Server 24 also serves up an initial screen to be shown on display screen 28 of computer 26. For example, an EMR screen based on information stored in an EMR server 29 is displayed on screen 28 of computer 26 with the information for the patient corresponding to tag 18. Thus, login server 24 notifies EMR server 29 to provide the EMR screen with the patient's information to computer 26 as part of the automatic login process. Of course, the EMR screen is given as one example of the initial screen to be shown computer 26 when the caregiver is automatically logged into computer 26.

It is contemplated by this disclosure that the initial screen of computer 26 is any screen available in system 10 from computer devices (e.g., computers, servers, medical equipment, and so forth) included in or coupled to network 22 that the caregiver, or a systems administrator, sets up as being the initial screen using server 24. Alternative initial screens include, for example, a laboratory screen to show the patient's laboratory results, a scheduling screen showing the patient's schedule, a pharmacy screen showing the patient's medications, a bed status screen showing the status of a bed in room 12, or a physician's orders screen showing the physician's orders for the patient, just to name a few. In the case of these respective alternative screens, server 24 coordinates with the respective server (e.g., laboratory server, scheduling server, pharmacy server, bed status server, physician's order server, and so on) to provide the initial screen information to computer 26 in response to the automatic log in of the caregiver to computer 26. One or more of these alternative servers are included in network 22 in some embodiments. Thus, the depiction of EMR server 29 in FIG. 1 is representative of all of these alternative servers as well.

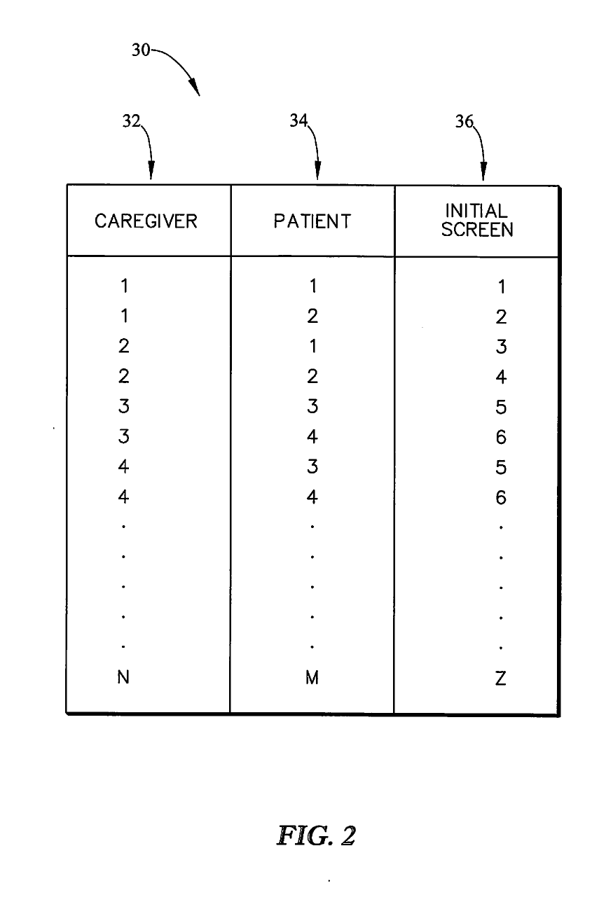

Based on the foregoing, therefore, it should be appreciated that server 24 has a database 30, shown diagrammatically in FIG. 2, to indicate which combination of caregivers and patients result in which initial screen being shown on display 28 of computer 26 in connection with the automatic log in process. In FIG. 2, database 30 is illustrated as a table having a caregiver column 32, a patient column 34, and an initial screen column 36. Thus, database 30 is sometimes referred to herein as table 30. In the illustrative example, there are up to N caregivers, M patients, and Z initial screens, with each of N, M and Z being integers corresponding to the number of caregivers, patients and possible initial screens stored in the database 30 of server 24.

Referring to the first two rows in table 30 beneath the header row that contains the words “CAREGIVER,” “PATIENT,” and “INITIAL SCREEN,” if a first caregiver (i.e., caregiver 1) is detected to be in the same room 12 as a first patient (i.e., patient 1), then a first initial screen (i.e., initial screen 1) is shown on display 28 of computer 26 in room 12 after caregiver 1 has automatically been logged into the computer 26. If caregiver 1 goes into room 12 having a second patient (i.e., patient 2), then a second initial screen (i.e., initial screen 2) is shown on display 28 of computer 26 in room 12 after caregiver 1 has automatically been logged into the computer 26. Thus, the first two rows in table 30 are illustrative, for example, of a situation in which an EMR screen for patient 1 is the initial screen 1 that appears on the display 28 of computer 26 of the respective room 12 in which patient 1 and caregiver 1 are located and in which an EMR screen for patient 2 is the initial screen 2 that appears on display 28 of computer 26 of the respective room 12 in which patient 2 and caregiver 1 are located.

Referring now to the third and fourth rows of table 30, if a second caregiver (i.e., caregiver 2) is detected to be in the same room 12 as patient 1, then a third initial screen (i.e., initial screen 3) is shown on display 28 of computer 26 in room 12 after caregiver 2 has automatically been logged into the computer 26. If caregiver 2 goes into room 12 having patient 2, then a fourth initial screen (i.e., initial screen 4) is shown on display 28 of computer 26 in room 12 after caregiver 2 has automatically been logged into the computer 26. Thus, the third and fourth rows in table 30 are illustrative, for example, of a situation in which caregiver 2 is set up in server 24 to have initial screens that are different than those of caregiver 1 for the same patient. So, for example, caregiver 2 may be pharmacist or a pharmacy technician that prefers to see pharmacy information for patients 1 and 2 when entering the respective rooms 12 of those patients, whereas caregiver 1 prefers to see EMR information for patients 1 and 2 when entering the respective rooms 12 of those patients.

Referring now to the fifth through eighth rows of table 30, if caregiver 3 or caregiver 4 is detected to be in the same room as patient 3, then initial screen 5 is displayed on display 28 of computer 26 in the respective room 12 after caregiver 3 or caregiver 4, as the case may be, has automatically been logged into the computer 26. If caregiver 3 or caregiver 4 is detected to be in the same room as patient 4, then initial screen 6 is displayed on display 28 of computer 26 in the respective room 12 after caregiver 3 or caregiver 4, as the case may be, has automatically been logged into the computer 26. Thus, the fifth through eighth rows of table 30 represent the situation in which two caregivers prefer the same initial screen for particular patients when they enter the patients room.

It is contemplated by this disclosure that, if two or more caregivers are detected by RTLS receiver 14 to be in the same room at the same time, then server 24 implements a prioritization routine to determine which caregiver of the multiple caregivers has the highest prioritization in connection with the particular patient in the respective room 12. For example, patients are often assigned a first nurse as a primary caregiver and second nurse as a secondary caregiver. In such situations, if the primary and secondary caregivers are in the patient's room 12 at the same time, then the initial screen for the primary caregiver is the one shown on display 28 of the corresponding computer 26 in room 12.

In some embodiments, if a doctor enters the room 12 in which a caregiver having lower priority, as programmed in server 24, is located, then server 24 will automatically log the caregiver out of computer 26 and automatically log the doctor in to computer 26 with the doctor's preferred initial screen being shown on display 28. In other embodiments, the caregiver's screen will remain on screen 28 of computer 26 for a predetermined period of time after the doctor enters the room 12 or until the caregiver logs out. In some embodiments, a caregiver may be prompted on display 28 to log out 26 in response entry of a doctor into the room 12 as detected by RTLS receiver 14. The scenarios just described are applicable to any scenarios in which higher priority personnel enters a room in which lower priority personnel are already located and are not just applicable to the doctor/nurse situation. In some embodiments, if two people having the same prioritization level stored in server 24 are detected in the room 12, then server 24 operates to display the initial screen on display 28 of computer 26 that is preferred by the first person detected in the room 12.

In some embodiments, if the patient leaves the room 12, there is no effect on the screen that is displayed on display 28 of computer 26 and the caregiver in room 12 remains logged into computer 26 as long as the caregiver continues to remain in room 12 after the patient has left. If, however, the caregiver leaves the room 12 while the patient is still in the room 12, then screen 28 becomes blank or shows a screen saver in some embodiments. Alternatively or additionally, the caregiver is logged out of computer 26 when the caregiver leaves the room. Thus, in some embodiments, the caregiver is logged out to computer 26 by server 24 as soon as is practicable after server is notified by RTLS server 20 that the caregiver has left the room 12. In other embodiments contemplated by this disclosure, a blank or screen saver screen appears on the display 28 for a predetermined amount of time, such as an amount of time set up by the caregiver or system administrator using server 24, and then the caregiver is logged out of computer 26 if the caregiver does not return to the room 12 within the predetermined amount of time.

According to this disclosure, the caregiver is able to log out of computer 26 at any time by manually entering commands into computer 26 to do so. For example, if a person without a tag 16 or if a lower priority person enters the room 12 and the caregiver wishes to relinquish control of computer 26 to that person, the caregiver is able to log out of computer 26 so that the other person can log in or otherwise use computer 26.

Further according to this disclosure, server 24 operates to command computer 26 to display an initial screen on display 28 of computer 26 in response to RTLS receiver 14 sensing a tag, similar to tags 16 and 18, that is attached to an asset, such as a piece of medical equipment. At the option of the system programmer, the initial screen established in server 24 is dependent upon the presence in the room 12 of the asset without regard to the presence of other people or assets, the presence in the room 12 of the asset in combination with a particular caregiver, or the presence in the room 12 of the asset in combination with a particular caregiver and a particular patient. For example, if an imaging machine is wheeled into room 12 and RTLS receiver 14 detects a tag on the imaging machine (and server 20 notifies server 24 of the presence of the imaging machine in the room 12), then an imaging screen from an imaging server is automatically displayed on display 28 of server 26. The associated caregiver continues to be logged into computer 26 as well in some embodiments.

It is further contemplated by this disclosure that assets also have prioritization levels as compared to other assets and as compared to caregivers so that server 24 determines which assets will cause a new screen to be shown on display 28 of computer when the asset is brought into room 12 and which assets won't cause a change in the screen displayed on display 28. So, in keeping with our example of an imaging machine being present in the room 12, if an IV pump is subsequently brought into room 12 and has a tag sensed by RTLS receiver 14, the imaging screen will continue to appear on display 28 if the IV pump has a lower prioritization level stored in server 24 than does the imaging machine. In some embodiments, if two pieces of equipment having the same prioritization level stored in server 24 are detected in the room 12, then server 24 operates to display the initial screen on display 28 of computer 26 that is associated with the first piece of equipment detected in the room 12.

Based on the foregoing, it will be appreciated that system 10, as disclosed herein, uses RTLS information tracking staff, assets and patients to automatically launch the appropriate section of an EMR and/or other portion of Hospital Information Systems (HIS). For example, a caregiver enters room 12 that contains computer 26 and a patient. Using RTLS information to identify the asset (computer), the caregiver and the patient in the room 12, server 24 of system 10 automatically logs the caregiver into the EMR and opens the patient's record, for example.

According to this disclosure, a software application is installed on hospital computers 26 and/or server 24. The software application is configured to “know” the room where the computer 26 is located (either through configuration or using an RTLS asset tag). The software application is also configured to “know” what patient is in the room (e.g., either through an ADT feed or using RTLS patient tags 18). When a caregiver enters the patient room 12 and is detected in the RTLS system using a staff tag 16, an event is received by the application software letting it know the caregiver has entered the room 12. Upon receipt of the event indicating the caregiver has entered the room 12, the software application launches the patient's EMR using the located caregiver's credentials (e.g., user ID and password) and opens the medical record of the patient located in the room. Thus, system 10 operates to save the caregiver from needing to take the time to log into system 10 and navigating to the correct patient record.

Although certain illustrative embodiments have been described in detail above, many embodiments, variations and modifications are possible that are still within the scope and spirit of this disclosure as described herein and as defined in the following claims.

1. A system comprising
a first identification token carried by a caregiver,
a second identification token carried by a patient,
a receiver located in a patient room and operable to communicate wirelessly with the first and second identification tokens when the first and second identification tokens are located in the patient room,
a computer located in the patient room and having a display screen,
at least one server in communication with the receiver, the at least one server associating the caregiver and the patient with the patient room based on information received from the receiver and sent to the first server,
wherein, based on the at least one server associating the caregiver and the patient with the room, the at least one server determines an initial screen from among a plurality of possible initial screens to be shown on the display screen of the computer, wherein the at least one server sends the computer at least one message that automatically logs the caregiver into the computer and results in the initial screen being displayed on the display screen of the computer.

2. The system of claim 1, wherein the caregiver is logged out of the computer automatically in response to the first identification token losing communication with the receiver for a threshold amount of time.

3. The system of claim 1, wherein the initial screen ceases to be displayed on the display screen in response to the first identification token losing communication with the receiver for a threshold amount of time.

4. The system of claim 1, wherein the caregiver is logged out of the computer automatically in response to the caregiver leaving the patient room.

5. The system of claim 1, wherein the initial screen ceases to be displayed on the display screen in response to the caregiver leaving the patient room.

6. The system of claim 1, wherein after the caregiver is logged into the computer, the caregiver remains logged into the computer even if the second identification token loses communication with the receiver for a threshold amount of time.

7. The system of claim 1, wherein after the caregiver is logged into the computer, the initial screen remains displayed on the graphical display even if the second identification token loses communication with the receiver for a threshold amount of time.

8. The system of claim 1, wherein after the caregiver is logged into the computer, the caregiver remains logged into the computer even if the patient leaves the patient room.

9. The system of claim 1, wherein after the caregiver is logged into the computer, the initial screen remains displayed on the graphical display even if the patient leaves the patient room.

10. The system of claim 1, wherein the initial screen includes information obtained from an electronic medical record (EMR) of the patient.

11. The system of claim 1, wherein the at least one server receives computer identification data that identifies the computer and the at least one server also associates the computer identification data with the room.

12. The system of claim 11, wherein the at least one server comprises a first server and a second server and wherein the computer identification data is communicated to the first server via the second server.

13. The system of claim 11, wherein the computer identification data is communicated to the at least one server via the receiver.

14. The system of claim 13, further comprising a third identification token coupled to the computer, the third identification token transmitting the computer identification data to the receiver.

15. A system comprising
a first identification token carried by a caregiver,
a second identification token carried by a patient,
a receiver located in a patient room and operable to communicate wirelessly with the first and second identification tokens when the first and second identification tokens are located in the patient room,
a computer located in the patient room and having a display screen,
a server in communication with the receiver, the server associating the caregiver and the patient with the patient room based on information received from the receiver and sent to the server,
wherein the server transmits association data to the computer indicating the association of the caregiver and the patient with the room, wherein in response to receipt of the association data, the computer automatically logs the caregiver into the computer and displays on the display screen information pertaining to the patient.

16. The system of claim 15, wherein the caregiver is logged out of the computer automatically in response to the first identification token losing communication with the receiver for a threshold amount of time.

17. The system of claim 15, wherein the caregiver is logged out of the computer automatically in response to the caregiver leaving the patient room.

18. The system of claim 15, wherein after the caregiver is logged into the computer, the caregiver remains logged into the computer even if the second identification token loses communication with the receiver for a threshold amount of time.

19. The system of claim 15, wherein after the caregiver is logged into the computer, the caregiver remains logged into the computer even if the patient leaves the patient room.

20. The system of claim 15, wherein the information pertaining to the patient is obtained from an electronic medical record (EMR) of the patient.
